(19) United States
(12) Patent Application Publication
(10) Pub. No.: US 2005/0175069 A1
(43) Pub. Date: Aug. 11, 2005

(54) Electromagnetic wave receiver front ends

(75) Inventors: Christopher Zelley, Malvern (GB); Robert Ashcroft, Malvern (GB); Andrew R. Barnes, Malvern (GB); David C. Bannister, Malvern (GB); Gwendoline F. Ashcroft, Malvern (GB)

Correspondence Address: NIXON & VANDERHYE, PC, 901 NORTH GLEBE ROAD, 11TH FLOOR, ARLINGTON, VA, 22203, US

(73) Assignee: QINETIQ LIMITED, Farnborough (GB)

(21) Appl. No.: 10/654,635

(22) Filed: Sep. 4, 2003

Related U.S. Application Data
(63) Continuation of application No. 10/291,749, filed on Nov. 12, 2002, now abandoned.
Application No. 10/291,749 is a continuation of application No. 10/048,624, now abandoned.

(30) Foreign Application Priority Data
Aug. 5, 1999 (GB) 9918399.8

(51) Int. Cl. H04B 1/69

(52) U.S. Cl. 375/136

(57) ABSTRACT

A receiver front end is provided capable of receiving electromagnetic wave signals having frequencies in the range of substantially 55 GHz to substantially 65 GHz, and having a gain of substantially 8 dB or above and a noise figure of substantially 4.5 dB or below, and comprising one or more multifunction monolithic microwave integrated circuits (MMICs). The or each MMIC may comprise a low noise amplifier (1), a sub-harmonic mixer (2), and an amplifier (3) for a reference signal for the sub-harmonic mixer.

This invention relates to improvements in electromagnetic wave receiver front ends capable of receiving waves having frequencies in the radio frequency range, and the components used therefor.

There are a number of applications where it is desirable to be able to receive electromagnetic waves having frequencies in the radio frequency range, especially in the range of ten's of gigahertz. In particular, it is desirable to be able to receive radio frequencies in the region of 60 GHz. Such signals are strongly absorbed by the atmosphere, and can therefore only be received over short distances, making their use suitable for short range communication applications. For receiver technology e.g. receiver front ends for such applications to be successful in the market place, it is important that acceptable performance is achieved while, at the same time, component size and cost is minimised. This is particularly the case with regard to size, at present receiver technology in this frequency range comprises very bulky components e.g. wave guides. These limit the usefulness of such technology.

According to a first aspect of the present invention, there is provided a receiver front end capable of receiving electromagnetic wave signals having frequencies in the range of substantially 50 GHz to substantially 70 GHz, and comprising one or more multifunction monolithic microwave integrated circuits (MMICs).

The receiver front end is preferably capable of receiving electromagnetic wave signals having frequencies in the range 55 to 65 GHz. The receiver front end preferably has a noise figure of substantially 4.5 dB or below. The receiver front end preferably has a conversion gain of substantially 8 dB or above. The receiver front end preferably has a total DC power consumption of less than 500 mW, e.g. 460 mW or less.

The receiver front end preferably has a size in the region of 15 mm², or less than this, for example 14 mm² or 13 mm² or 12 mm². The receiver front end preferably has a size of 12.76 mm². The receiver front end is preferably elongate. The receiver front end preferably has a size of 5.8 mm×2.2 mm, i.e. the ratio of the length to the width is preferably large. The receiver front end preferably has a width of less than half the wavelength of the received electromagnetic signals, or less than half of the shortest wavelength of the received electromagnetic signals when these comprise a range of frequencies/wavelengths. When the receiver front end is elongate, the electromagnetic wave signals may be received at a first end of the receiver front end, and an output may be provided at the second end thereof. One or more voltage source connections may be provided at the second end of the receiver front end. An input for a reference signal may be provided at the second end of the receiver front end. The reference signal may be provided by a local oscillator. The size of the receiver front end is to be compared with known 60 GHz front ends which typically have a size dominated by waveguide dimensions, much greater than 25 mm². The receiver front end of this invention therefore represents a substantial improvement over known technology. The size of the receiver front end may allow use thereof in a number of applications. For example, in phased array applications, particularly phased array applications in the radio frequency range, the electromagnetic wave receiver front ends are required to be placed close together and need to be small in size. It is particularly advantageous if the receiver front ends are elongate, connection to an antenna of the phased array can be made at one end of each receiver front end, and an output, voltage source connections and an input for a reference signal can be made at the other end thereof. One or more receiver front ends may be incorporated in one or more phased array modules.

The receiver front end may be connected to one or more microstrip lines by, for example, 50 μm gold tape bonds.

Using one or more multifunction MMICs in receiver front ends has a number of advantages. They have small size and weight, good reliability and repeatability, and low cost. This allows receiver front ends incorporating such MMICs to be easily replaceable if they fail. In addition, when single function MMICs are used in a receiver front end, connections, such as tape bonds, bond wires or flip MMIC connections, need to be provided between these. At each connection there is the possibility of the introduction of interface parasitics into the signal path, and such connections tend to filter high frequency (i.e. ten's of gigahertz) signals which is undesirable. Further, the connections have to be very short to be usable in practice. By using one or more multifunction MMICs the number of MMICs required in an equivalent receiver front end is reduced, thereby reducing the number of connections required and the possibility of parasitics etc. In addition, when a multiple of single function MMICs are used in a receiver front end, these may be manufactured from more than one semiconductor wafer and by more than one semiconductor manufacturing process. This may introduce differences in the operation of the MMICs due to differences in the semiconductor wafers or processing. When multifunction MMICs are used all of the functions may be included on the same wafer and on the same area of the wafer. This reduces the possibility of process differences between MMICs, and produces a smaller spread in performance characteristics than with the use of multiple single function MMICs.

The or each multifunction receiver front end MMIC may carry out two or more functions. These functions may comprise amplification of the electromagnetic wave signals received by the MMIC and conversion of the frequency or frequencies of the electromagnetic wave signals to a lower frequency or frequencies. The or each MMIC may have a GaAs substrate. The or each MMIC may be fabricated using a GaAs foundry process.

The or each MMIC may comprise a low noise amplifier (LNA). This is preferably the first component of the receiver front end and receives the electromagnetic wave signals, for example via an input port. These signals may be received via a microstrip transmission line, or a co-planar wave guide, or a grounded co-planar wave guide. The LNA preferably comprises an output port. The LNA preferably has an operating band of at least 55-65 GHz. The LNA preferably has a gain in the region of 18 dB or, more preferably, greater than 18 dB. The input and output port return losses are preferably better than 12 dB, and the noise figure preferably less than 4.5 dB.

The LNA may comprise a number of stages of amplification, e.g. at least three stages, e.g. four stages. These enable a gain specification of greater than 18 dB to be met. It is important that the LNA has good gain characteristics as this minimises the effect of any noise contribution to the following components of the receiver front end MMIC. It is important that the noise introduced by the receiver front end and the receiver as a whole is as low as possible, as the receiver front end and the receiver are usually the first components in a receiver chain and any noise introduced in the first component will degrade the noise performance of the chain. Each stage of amplification may be provided with one or more transistors, such as a pseudomorphic high electron mobility transistor (PHEM™). In a preferred embodiment, the LNA comprises four stages of amplification, each provided with one PHEMT. The PHEMTs of the first and second stages preferably each comprise four fingers, each of 20 μm width. The PHEMT of the third stage preferably comprises four fingers, each of 30 μm width. The PHEMT of the fourth stage preferably comprises eight fingers, each of 251 μm width. The gate length of the or each PHEMT may be 0.15 μm.

Each transistor is preferably provided with a DC drain bias, preferably via one or more drain bias pads and tracks. Each transistor is preferably provided with a DC gate bias, preferably via one or more gate bias pads and tracks. The or each or some of the drain bias pads may be provided with a via hole, which may connect the pad to the back plane of the MMIC, preferably through a de-coupling capacitor. The or each or some of the gate bias pads may be provided with a via hole, which may connect the pad to the back plane of the MMIC, preferably through a de-coupling capacitor. This provides low frequency stabilisation. The or each drain bias track may be connected to a common drain line. The or each gate bias track may be connected to a common gate line. Only a single drain bias connection to the drain line and a single gate bias connection to the gate line are then required. This provides ease of use of the LNA.

The or each or some of the drain bias tracks may be provided with one or more radio frequency (RF) de-coupling elements. Similarly, the or each or some of the gate bias tracks may be provided with one or more RF de-coupling elements. These elements preferably act to connect any RF signal passing along the track to ground. This helps to prevent such signals from reaching the drain or gate lines. The or each or some of the de-coupling elements may comprise a capacitor. The or each or some of the capacitors may be provided with a via hole. The or each or some of the de-coupling elements may comprise a radial stub. In a preferred embodiment, the de-coupling elements comprise at least one radial stub, and at least one capacitor with via hole. The former preferably have low capacitance, and preferably act to connect high frequency components of the RF signal to ground. The latter preferably act to connect lower frequency components of the RF signal to ground. The or each or some of the drain bias tracks may be provided with one or more resistors. Similarly, the or each or some of the gate bias tracks may be provided with one or more resistors. These preferably provide low frequency stabilisation on the or each track.

The or each or some of the transistors of the LNA may be provided with one or more, e.g. two, source connections. The or each source connection may be provided with via holes for connection thereto to the back plane of the MMIC.

The LNA may be provided with an input line, connected to the input port. One or more impedance matching elements may be provided in the input line. It is important to have good impedance matching between the input of the LNA, and any circuit connected to this input for use (such as an antenna circuit). When a difference occurs between these impedances, a portion of the electromagnetic wave signals will be reflected at the input of the LNA. The LNA is preferably designed assuming that the impedance of any circuit connected to its input for use is 50 Ω. This is a standard assumption in the design of such apparatus.

The LNA may comprise an output line, connected to the output port. One or more impedance matching elements may be provided in the output line. The impedance matching elements of the output line and of the input line may comprise one or more capacitors such as metal-insulator-metal (MIM) capacitors, and/or one or more transmission line elements. When two or more transmission line elements are provided these may have different widths.

One or more impedance matching elements may be provided between the amplification stages of the LNA, preferably between the transistor or transistors of each amplification stage. These elements may comprise one or more capacitors such as MIM capacitors, and/or one or more transmission line elements. When two or more transmission line elements are provided these may have different widths. In a preferred embodiment, the LNA comprises four amplification stages each having one transistor, and impedance matching elements are provided between the transistor of each stage. These elements preferably comprise a first transmission line element followed by a MIM capacitor followed by a second transmission line element. The second transmission line element is preferably of greater width than the first transmission line element. The first, narrower, transmission line element preferably acts as an inductor, the second, wider, transmission line element preferably acts as an impedance transformer. This allows impedance matching between first and a second transistors to be achieved, where the first transistor has a higher impedance than the second transistor.

All impedance matching preferably takes place over a well-defined frequency band, preferably over the operating frequency band of the MMIC, preferably over 50-70 GHz, more preferably over 55-65 GHz.

The or each MMIC preferably comprises a mixer. This preferably receives an output signal from the LNA and converts this to a lower frequency mixer output signal. The mixer output signal may have a frequency or frequencies in the intermediate frequency (IF) range. The lower frequency signal may be output from the mixer to further stages of the receiver front end MMIC, or to a component to which the receiver front end MMIC is attached for use. The output signal from the LNA may comprise a range or band of frequencies and this may be converted to a mixer output signal having a range or band of lower frequencies. The frequencies of the mixer output signal may be centered around or may have a mid-band frequency in the IF range, e.g. in the range 8 to 15 GHz, preferably substantially 11 GHz. Such an IF signal can be more easily processed than the higher frequency signal from the LNA. The aim is to retain as much information in the signal from the LNA as possible, whilst reducing its frequency so that it can be more easily analysed.

The mixer may be a sub-harmonic mixer. The sub-harmonic? mixer may be a balanced sub-harmonic? mixer. The sub-harmonic? mixer preferably comprises two diodes. Each of these may comprise two fingers of 20 μm width. The diodes may be positioned in the mixer back-to-back. An output signal from the LNA is preferably fed into the sub-harmonic mixer, for example directly or indirectly to the diodes, along with a reference signal, comprising a range or band of frequencies. The sub-harmonic mixer preferably outputs a signal having a mid-band frequency substantially equal to the difference in mid-band frequency of the output signal from the LNA and twice the mid-band frequency of the reference signal. If the mid-band frequency of the output signal from the LNA is approximately 60 GHz and the mid-band frequency of the reference signal is approximately 24.5 GHz, then the mid-band frequency of the signal output from the mixer will be approximately 11 GHz. The reference signal is preferably provided by a local oscillator (LO). The sub-harmonic mixer may comprise a first input port which receives the output signal from the LNA, a second input port which may receive the reference signal, and an output port through which a signal from the mixer may be output. One or more open circuited radial stubs may provide isolation between the ports.

Using a sub-harmonic mixer allows a reference signal of lower frequency to be used than would be possible if a non sub-harmonic mixer were used. Using a sub-harmonic mixer may allow a reference signal of half the frequency of a conventional reference signal to be used. Such lower frequency reference signals are easier to generate than higher frequency reference signals, and facilitates use of the receiver front end. In addition, when the power for the sub-harmonic mixer is supplied by the reference signal, the required power level of the signal is less than that which would be required if a non sub-harmonic mixer were used. The use of a lower frequency, lower power level reference signal has significant cost implications.

The or each MMIC preferably comprises an amplifier. The amplifier may be a feed-back amplifier. The amplifier may comprise one or more amplification stages, but preferably one stage. The or each stage may comprise one or more transistors, which may be PHEMTs. The amplifier preferably has a gain of approximately 7-8 dB. The amplifier preferably gives an output power of approximately 2 mW. The amplifier preferably operates over a frequency range of at least 20-27 GHz. The input and output port return losses of the amplifier are preferably better than 7 dB.

The or each transistor of the amplifier is preferably provided with a DC drain bias, preferably via one or more drain bias pads and tracks. The or each transistor is preferably provided with a DC gate bias, preferably via one or more gate bias pads and tracks. The or each or some of the drain bias pads may be provided with a via hole, which may connect the pad to the back plane of the MMIC, preferably through a de-coupling capacitor. The or each or some of the gate bias pads may be provided with a via hole, which may connect the pad to the back plane of the MMIC, preferably through a de-coupling capacitor. This provides low frequency stabilization. The or each drain bias track is preferably connected to the common drain line of the LNA. For the entire MMIC, only a single drain bias connection and two gate bias connections (one for the LNA and one for the amplifier) are then required. This provides ease of use of the MMIC. The or each or some of the drain bias tracks may be provided with one or more RF de-coupling elements. Similarly, the or each or some of the gate bias tracks may be provided with one or more RF de-coupling elements. These elements preferably act to connect any RF signal passing along the track to ground. In the case of the or each drain bias tracks, this helps to prevent such signals from reaching the drain line of the LNA which would cause oscillation in the MMIC. The or each or some of the de-coupling elements may comprise a capacitor. The or each or some of the capacitors may be provided with a via hole. The or each or some of the de-coupling elements may comprise a radial stub. In a preferred embodiment, the de-coupling elements comprise at least one capacitor with via hole. The or each or some of the drain bias tracks may be provided with one or more resistors. Similarly, the or each or some of the gate bias tracks may be provided with one or more resistors. These preferably provide low frequency stabilisation on these tracks.

The amplifier preferably amplifies the reference signal from the LO prior to this being received by the mixer. The amplifier preferably comprises an input port into which the reference signal from the LO is fed. The amplifier preferably provides the power to drive the mixer. The power to drive the mixer may be supplied by the amplified reference signal. Due to the amplification of this signal, the input power level thereof will be less than that required if the reference signal were not amplified.

The or each MMIC may be provided with one or more test pads. The or each pad may be a ground-signal-ground pad. The or each pad may be used to test the function of the MMIC. The function of a number of MMICs from a single wafer can be tested, allowing the position of good/bad chips within the wafer to be assessed. This part of a manufacturing process may include testing chips using such test pads, and noting or rejecting the failed chips. The or each MMIC may be provided with one or more ground pads. The or each ground pad may be provided with a via hole, which may connect the pad to the back plane of the MMIC. When the MMIC or a number of MMICs are tested, the or each MMIC needs to be connected to ground. This may be achieved by the ground pad or pads.

The or each MMIC is preferably elongate. The width of the or each MMIC is preferably less than half the wavelength of the received electromagnetic signals, or less than half of the shortest wavelength of the received electromagnetic signals when these comprise a range of frequencies/wavelengths. The input port of the LNA may be provided at a first end of the MMIC. The input port of the amplifier may be provided at a second end of the MMIC. The output port for the IF signal of the mixer may be provided at the second end of the MMIC. The or each drain bias connection and the or each gate bias connection may be provided at the second end of the MMIC. As previously stated, this arrangement is particularly advantageous when the receiver front end is to be incorporated in a phased array module.

In a preferred embodiment, the receiver front end comprises one multifunction MMIC, which preferably carries out three functions. The three functions may comprise amplification of the electromagnetic wave signals received by the MMIC, conversion of the frequency or frequencies of the electromagnetic wave signals to a lower frequency or frequencies, and amplification of a reference signal used in the conversion of the electromagnetic signals. The MMIC may comprise a LNA, a mixer and an amplifier as described above. Such a receiver front end integrates the core functions necessary to receive electromagnetic signals of approximately 60 GHz on a single multifunction MMIC of small size.

The entire receive function is performed by the MMIC circuit. Such functionality on a MMIC of this size is a major achievement, and represents a substantial improvement over prior art receiver front ends. The gain and noise figures of the receiver front end of the invention are also a substantial improvement over what is currently available.

The receiver front end may be connected to an antenna, which detects the electromagnetic waves. The antenna may be movable through a substantial angle, for example the antenna may be used in a telecoms link or a sweeping radar system. Conventional receiver front ends connected to such antennas have to be able to transmit high frequency signals through a movable joint which is difficult to achieve. The receiver front end of the invention, because of its small size, can be mounted on the antenna or a movable component thereof and can move with the antenna. The receiver front end will convert the high frequency electromagnetic waves received by the antenna to an IF output signal. This signal is fed to subsequent components via the movable joint, but because of its decreased frequency, realisation of the movable joint is much easier.

According to a second aspect of the present invention there is provided a receiver comprising a receiver front end according to the first aspect of the invention.

The receiver preferably comprises a movable antenna. The receiver front end is preferably movable with the antenna.

According to a third aspect of the present invention there is provided a phased array module comprising one or more receiver front ends according to the first aspect of the invention.

The invention will now be further described by way of example only, with reference to the accompanying drawings, in which:

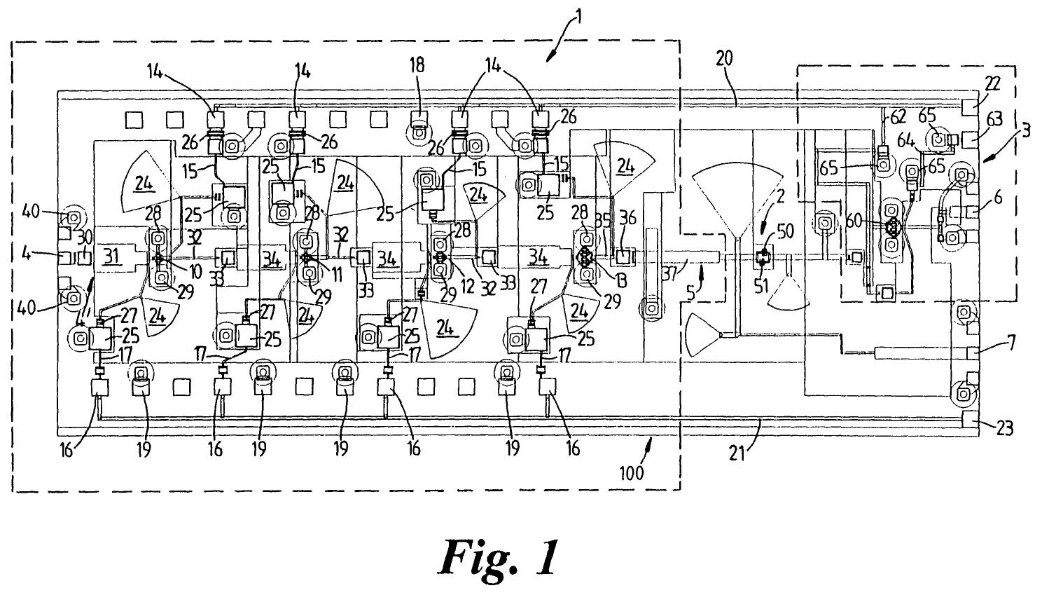

FIG. 1 is a circuit diagram of a receiver front end according to the present invention, and

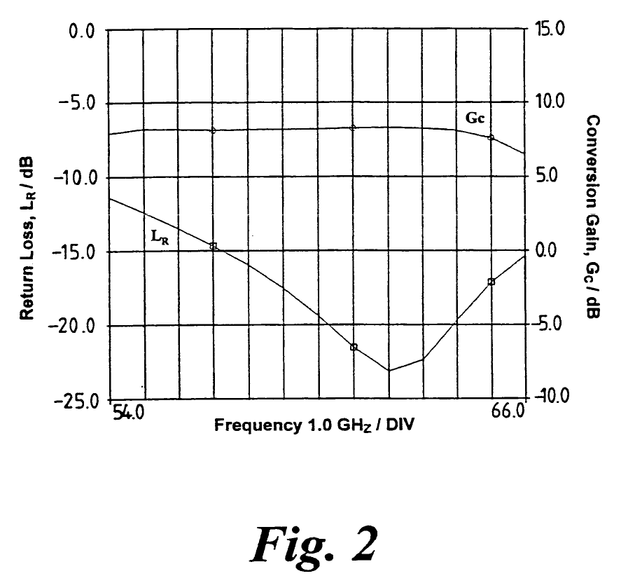

FIG. 2 shows the gain conversion and the input port return loss of the receiver front end of FIG. 1.

A circuit diagram of an electromagnetic wave receiver front end architecture according to the invention is shown in FIG. 1. This comprises a single multifunction MMIC 100. The MMIC comprises a low noise amplifier (LNA) 1, a sub-harmonic mixer 2, and a local oscillator (LO) amplifier 3. The electromagnetic wave signal to be detected is fed into the input port 4 and along the input line 4′ of the MMIC LNA 1. The output signal of the LNA 1 is fed via an output line 5 and output port to the mixer 2. The LO amplifier 3 has an input port 6 into which is fed a reference signal from a local oscillator (LO). The LO is not part of the MMIC 100. The output signal of the LO amplifier 3 is fed to the sub-harmonic mixer 2. This signal and that from the LNA 1 are mixed in the mixer 2, resulting in an intermediate frequency (IF) output signal from the mixer 2 having the characteristics of the detected signal but at a lower frequency. This IF signal is fed to an output port 7 of the MMIC mixer, and from there is output from the receiver front end. The components of the MMIC 100 will now be described in more detail.

The LNA 1 comprises the front end of the receiver MMIC 100 and receives the electromagnetic wave signals. The LNA 1 uses four stages of amplification. Each stage of amplification is provided with a PHEMT 10,11,12,13. The PHEMTs 10,11 of the first and second stages respectively each comprise four fingers, each of 201 μm width. The PHEMT 12 of the third stage comprises four fingers, each of 30 μm width. The PHEMT 13 of the fourth stage comprises eight fingers, each of 251 μm width. The gate length of each PHEMT is 0.15 μm. Each transistor is provided with a DC drain bias, via drain bias pads 14 and tracks 15, and a DC gate bias via gate bias pads 16 and tracks 17. All the drain bias tracks 15 are connected to a common drain line 20, and all the gate bias tracks 17 are connected to a common gate line 21. Only a single drain bias connection 22 to the drain line 20 and a single gate bias connection 23 to the gate line 21 are then required. Each of the drain bias tracks 15 is provided with two radio frequency (RF) de-coupling elements. Similarly, each of the gate bias tracks 17 is provided with two RF de-coupling elements. These elements comprise a radial stub 24, and a capacitor with via hole 25. Each of the drain bias tracks 15 is provided with a resistor 26. Similarly, each of the gate bias tracks is provided with a resistor 27. These provide low frequency stabilisation on each track. Each transistor of the LNA 1 is provided with two source connections 28,29, each provided with via holes for connection thereof to the back plane of the MMIC 100.

The input line 4 is provided with impedance matching elements, comprising a metal-insulator-metal (MIM) capacitor 30 and a transmission line element 31. Impedance matching elements are provided between the transistor of each amplification stage. These elements comprise a first transmission line element 32, followed by a MIM capacitor 33, followed by a second transmission line element 34. The first, narrower, transmission line element acts as an inductor, the second, wider, transmission line element acts as an impedance transformer. This allows impedance matching between first and second transistors to be achieved, where the first transistor has a higher impedance than the second transistor. Impedance matching elements are provided in the output line 5, comprising a first transmission line element 35, followed by a MIM capacitor 36, followed by a second transmission line element 37. All impedance matching takes place over the operating frequency band of the MMIC, i.e. over at least 55-65 GHz.

The LNA 1 has an operating band of at least 55-65 GHz, a gain in the region of 18 dB or more, input and output port return losses better than 12 dB, and a noise figure less than 4.5 dB.

The sub-harmonic mixer 2 receives the signal output from the LNA 1 and converts this to a lower frequency mixer output signal. The mixer comprises two diodes 50,51, each comprising two fingers of 20 μm width. The diodes are positioned in the mixer back-to-back. The signal from the LNA 1 is fed into the diodes along with a reference signal, comprising a range or band of frequencies. The non-linearity of the diodes produces the second harmonic of the reference signal, which is mixed with the signal from the LNA 1. This multiplication generates an output signal having a mid-band frequency substantially equal to the difference in mid-band frequency of the signal from the LNA 1 and twice the mid-band frequency of the reference signal. If the mid-band frequency of the signal from the LNA 1 is approximately 60 GHz and the mid-band frequency of the reference signal is approximately 24.5 GHz, then the mid-band frequency of the signal output from the mixer will be approximately 11 GHz. The reference signal is provided by the local oscillator (LO) referred to above, which is external to the MMIC 100.

The LO amplifier 3 of the receiver front end MMIC 100 is a feed-back amplifier, comprising a single stage of amplification having one PHEMT 60. The LO amplifier 3 has a gain of approximately 7 to 8 dB. The LO amplifier 3 gives an output power of approximately 2 mW, and operates over a frequency range of approximately 20-27 GHz. The input and output port return losses of the LO amplifier 3 are greater than 7 dB.

The PHEMT 60 is provided with a DC drain bias, via a drain bias pad 61 and track 62, and a DC gate bias via a gate bias pad 63 and track 64. The drain bias track 62 is connected to the common drain line 20 of the LNA 1. For the entire MMIC 100, only a single drain bias connection 22 and two gate bias connections (one connection 23 for the LNA 1 and one connection 63 for the LO amplifier 3) are then required. This provides ease of use of the MMIC 100. The drain bias track 62 and the gate bias track 64 are provided with RF de-coupling elements. These elements act to connect any RF signal passing along the track to ground. In the case of the drain bias track, this helps to prevent such signals from reaching the drain line of the LNA 1 which would cause oscillation in the MMIC. The de-coupling elements comprise capacitors with via holes 65.

The LO amplifier 3 receives the reference signal from the LO via the input port 6, and amplifies this signal and feeds it to the sub-harmonic mixer 2. The LO amplifier provides the power to drive the mixer, via the amplified reference signal.

The MMIC 100 is provided with ground-signal-ground test pads 40. These can be used to test the function of the MMIC. The MMIC 100 is provided with ground pads 18, 19 also used when testing the MMIC. The ground pads are each provided with a via hole which connects the pad to the back plane of the MMIC. The ground pads provide a DC ground connection.

This receiver front end is capable of receiving electromagnetic wave signals having frequencies in the range 50 to 70 GHz, and at least 55 to 65 GHz. This receiver front end has a noise figure of substantially 4.5 dB or below, and a conversion gain of substantially 8 dB or above. This receiver front end has a total DC power consumption of 460 mW or lower. This receiver front end MMIC has a size of 5.8×2.2 mm i.e. an area of 12.76 mm². The receiver front end is elongate in shape. The input port 4 of the LNA 1 is provided at a first end of the receiver front end MMIC as shown in FIG. 1. The input port 6 of the LO amplifier 3 and the output port 7 of the mixer 2 are provided at a second end of the receiver front end MMIC. The drain bias connection 22 and the gate bias connections 23, 63 are also provided at the second end of the MMIC. The shape of the MMIC and the provision of the ports and bias connections in this way make the receiver front end particularly suitable for incorporation in a phased array module. Although the drain bias pads 14 and the gate bias pads 16 are connected to common lines and bias connections 22, 23 on the second end of the MMIC, direct connection could be made to these pads allowing DC bias connection to the sides of the MMIC 100.

The conversion gain and the input port return loss of this receiver front end MMIC are shown in FIG. 2.

1. A receiver front end characterized in that it is capable of receiving electromagnetic wave signals having frequencies in the range of substantially 50 GHz to substantially 70 GHz, and comprising one or more multifunction monolithic microwave integrated circuits (MMICs) (100).

2. A receiver front end according to claim 1 characterised in that it has a noise figure of substantially 4.5 dB or below.

3. A receiver front end according to claim 1 characterised by having a width of less than half the wavelength of the received electromagnetic wave.

4. A receiver front end according to claim 1 characterised in that the receiver front end is elongate and the electromagnetic wave signals are received at a front end, one or more voltage source connections and an input for a reference signal are provided at the second end of the receiver front end.

5. A receiver front end according to claim 1 characterised in that the or each MMIC (100) comprises a low noise amplifier (LNA) (1) which has a gain in the region of 18 dB or greater than 18 dB.

6. A receiver front end according to claim 5 characterised in that the LNA (1) has a noise figure less than 4.5 dB.

7. A receiver front end according to claim 5 characterised in that the LNA (1) comprises a number of stages of amplification each of which is provided with one or more pseudomorphic high electron mobility transistors (PHEMTs) (10, 11, 12, 13).

8. A receiver front end according to claim 7 characterised in that the or each transistor (10, 11, 12, 13) is provided with a DC drain bias via one or more drain bias pads (14) and tracks (15) and a DC gate bias via one or more gate bias pads (16) and tracks (17), and the or each drain bias track (15) is connected to a common drain line (20), and the or each gate bias track (17) is connected to a common gate line (21).

9. A receiver front end according to claim 1 characterised in that the or each MMIC (100) comprises a sub-harmonic mixer (2).

10. A receiver front end according to claim 9 characterised in that an output signal from the LNA (1) is fed into the mixer (2) along with a reference signal and the mixer (2) outputs a signal having a mid-band frequency substantially equal to the difference in mid-band frequency of the signal from the LNA (1) and twice the mid-band frequency of the reference signal.

11. A receiver front end according to claim 1 characterised in that the or each MMIC (100) comprises an amplifier (3) having a gain of approximately 7-8 dB.

12. A receiver front end according to claim 11 characterised in that the amplifier (3) operates over a frequency range of approximately 20-27 GHz.

13. A receiver front end according to claim 11 characterised in the amplifier (3) comprises one or more transistors (60) the or each of which is provided with one or more drain bias tracks (62) the or each which track (62) is connected to the common drain line (20) of the LNA (1).

14. A receiver front end according to claim 8 characterised in the amplifier (3) comprises one or more transistors (60) the or each of which is provided with one or more drain bias tracks (62) the or each of which track (62) is connected to the common drain line (20) of the LNA (1).

15. A receiver front end according to claims 11 to 14 as claim 9 characterised in that the amplifier (3) provides the power to drive the sub-harmonic mixer (2).
